(19) United States
(12) Patent Application Publication
(10) Pub. No.: US 2019/0175965 A1
(43) Pub. Date: Jun. 13, 2019

(54) SYSTEM AND METHOD OF REDUCING SPREAD OF WILDFIRES

(71) Applicant: Bryce Huefner, Garden City, UT (US)

(72) Inventor: Bryce Huefner, Garden City, UT (US)

(21) Appl. No.: 16/216,753

(22) Filed: Dec. 11, 2018

Related U.S. Application Data
(60) Provisional application No. 62/597,263, filed on Dec. 11, 2017.

(51) Int. Cl. A62C 3/02; A62C 35/13; A62C 37/38

(52) U.S. Cl. CPC A62C 3/0292; A62C 37/38; A62C 35/13; A62C 3/0271

(57) ABSTRACT

A system of reducing the spread of wildfires is provided. The system includes a fire retardant delivery system comprising one or more reservoirs containing a fluid under pressure and one or more distribution devices in fluidic communication with a single reservoir. One or more sensors for sensing characteristics of a fire may be configured in operable communication with the reservoirs and/or the distribution devices, such that upon direction from the sensors the fluid can be delivered to ambient surroundings. In addition, the system may include one or more conduits between the reservoir of fluid and the distribution devices, such that the conduits can elevate the distribution devices above surrounding buildings and vegetation to provide that the fluid is distributed about the reservoir without the surrounding building or vegetation interfering therewith.

### CROSS-REFERENCE TO RELATED APPLICATION

This is a non-provisional utility application that claims priority to U.S. provisional application Ser. No. 62/597,263, entitled System and Method for Reducing Spread of Wildfires, filed Dec. 11, 2017; the entire disclosure of which is incorporated herein by reference.

### BACKGROUND

### Technical Field

The present disclosure relates to fire control, and more particularly, to a system and method of reducing the spread of fire and wildfires.

### State of the Art

Fire and its varied uses are essential not only to day-to-day living, but also impact ecological systems around the globe. For example, the positive effects of fire include food preparation, heating, light, power, as well as stimulating growth and maintaining various environmental and ecological systems.

However, the negative effects of fire can include hazard to life and property, atmospheric pollution, and water contamination, among others. Indeed, fire has the potential to cause physical damage to structures, buildings, individuals, and other things through burning, not to mention the economic and environmental ramifications of such.

Accordingly, it would be advantageous to address the problems described above and develop an apparatus and method for reducing the spread of fire or, in particular, wildfire.

### SUMMARY

The present disclosure relates to fire control, and more particularly, to a system and method of reducing the spread of fire and wildfires.

An aspect of the present disclosure includes a fire retardant delivery system comprising one or more reservoirs containing a fluid under pressure; distribution devices in fluidic communication with the reservoir or reservoirs; and sensors for sensing characteristics of a fire, wherein the fluid is delivered to ambient surroundings upon direction from the sensor or sensors.

Another aspect of the present disclosure includes a conduit between the reservoir of fluid and the distribution device, wherein the conduit elevates the distribution device above surrounding buildings and vegetation.

Another aspect of the present invention includes a fire retardant delivery system comprising: a plurality of reservoirs containing a fluid under pressure, wherein the fluid contains a fire retardant; one or more distribution devices in fluidic communication with each of the reservoirs; and a sensor for sensing characteristics of a fire, wherein each of the reservoirs is positioned in sequence along a predetermined path, and wherein the fluid is delivered to ambient surroundings from each of the distribution devices upon direction from the sensor.

Another aspect of the present invention includes wherein the path is a fire line, geographic boundary, or other desired route.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1 is a side perspective view of an embodiment of an apparatus for reducing the spread of wildfire in accordance with the present disclosure;

FIG. 2 is a top view of an embodiment of an apparatus for reducing the spread of wildfire in accordance with the present disclosure;

FIG. 3 is a top view of an embodiment of a plurality of apparatuses, from FIG. 2, arranged and configured in a pattern and/or method of reducing the spread of wildfire in accordance with the present disclosure;

FIG. 4 is a top view of an embodiment of a plurality of apparatuses, from FIG. 2, arranged and configured in a pattern and/or method of reducing the spread of wildfire in accordance with the present disclosure;

FIG. 5 depicts a schematic view of a representative embodiment of the apparatus for reducing spread of wildfire, wherein the apparatus comprises multiple distribution devices; and

FIG. 6 depicts a schematic view of a representative embodiment of the apparatus for reducing spread of wildfire, wherein the apparatus comprises multiple distribution devices.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

The drawings depict illustrative embodiments of a fire retardant delivery system 10. These embodiments may each comprise various structural and functional components that complement one another to provide the unique functionality and performance of the system 10, the structure and function of which will be described in greater detail herein. For example, embodiments of the system 10 may comprise one or more of a reservoir 12, a conduit 18, and a distribution device 20, among other components to be described herein.

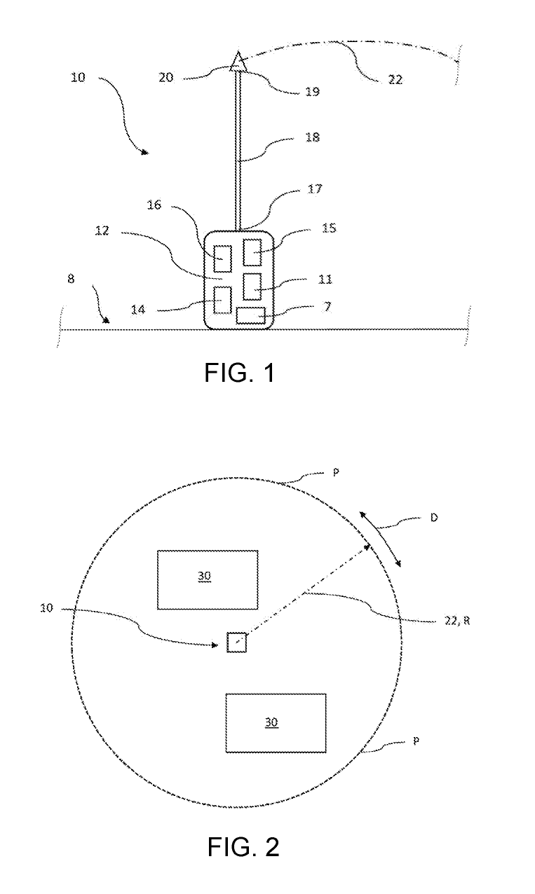

Referring to FIGS. 1 and 2, embodiments of the system 10 may comprise a reservoir 12. The reservoir 12 may be a tank, container, chamber, or other vessel capable of holding a fluid 22 therein. The reservoir 12 may be of a size, shape, and structural design consistent with holding gallons of fluid—hundreds, thousands, or even millions of gallons of fluid. The reservoir 12 may be designed such that it is self-contained, or, in other words, such that the fluid 22 may be inserted and contained within the reservoir 12, even for an extended duration, until release of the fluid 22 from the reservoir 12 through a valve 16 situated on or in conjunction with the reservoir 12.

Embodiments of the system may further comprise the reservoir 12 being fixed in place relative to a surface 8 upon, or by which, the reservoir 12 is supported. For example, the reservoir 12 may be set in, or on, a surface 8, such as the ground, and left in place. Alternatively, the reservoir 12 may be moveable or transportable, in that the reservoir 12 may be moved periodically from time to time, as desired or needed, from one surface 8 to another, such as one ground location to another ground location. Further in the alternative, the reservoir 12 may be a completely mobile unit, such that the reservoir 12 is not fixed or positioned permanently at any one particular location, but is instead portable to any desired location accessible by transport.

Embodiments of the system 10 may further comprise the reservoir 12 being a pressurized container. For example, the fluid 22 within the reservoir 12 may be set at a predetermined pressurized level. In other words, as the fluid 22 is inserted into the reservoir 12, the increasing volume of fluid 22, and other fluids, such as gases, with respect to the volume of the reservoir 12, may cause the pressure within the reservoir 12 to increase. The reservoir 12 may also be configured to be hermetically sealed so as to maintain the pressurized levels for an extended duration. However, as needed, according to circumstance and conditions, the pressure level of the fluid 22 may be adjustable, either at the time of filling the reservoir 12 or after the reservoir 12 has been filled, such as by a release valve (not depicted). Moreover, embodiments of the system 10 may comprise that once the reservoir 12 has ejected or emitted the fluid 22 contained therein, or once the pressure in the reservoir 12 has diminished to an unacceptable degree or level, the reservoir 12 may be recharged, refilled, or re-pressurized.

Embodiments of the system 10 may further comprise a conduit 18. The conduit 18 may be a tube, channel, pipe, hose, cylinder, or other elongated hollow member that is capable of facilitating the transport or movement of the fluid 22 therethrough. The conduit 18 may have a first end 17 that can be releasably coupled to the reservoir 12. The coupling of the conduit 18 to the reservoir 12 may be such that the fluid 22 may leave the reservoir 12, at the desired time by operation of the valve 16, travel into the first end 17, and then through the conduit 18. The conduit 18 may also have a second end 19 to which a distribution device 20 may be releasably coupled. The conduit 18 may have a length between the first end 17 and the second end 19. The length of the conduit 18 may be any desired length that permits the effective flow of the fluid 22 from the reservoir 12, to the distribution device 20, and out of the distribution device 20. For example, the conduit 18 may be configured to have a length and rigidity to position the distribution device 20 above any surrounding vegetation, such as trees, or buildings, such as commercial structures or residential dwellings. In this way, the spray of the fluid 22 from the disbursement device 20 over the perimeter P is not restricted or impeded. Moreover, the conduit 18 may be configured to extend or retract to position the distribution device 20. In other words, the conduit 18 may be extended to increase the height of the distribution device 20 above the immediate surroundings or may be retracted to decrease the height of the distribution device 20 to allow a user to access, adjust repair, and/or replace the distribution device 20.

Embodiments of the system 10 may comprise the distribution device 20. The distribution device 20 may be a nozzle, spout, spigot, sprinkler, or other similar fluid distribution outlet that is capable of directing the flow of the fluid 22 out of the conduit 18 under pressure from the reservoir 12. The distribution device 20 may be coupled to the conduit 18 at the second end 19. In the alternative, a plurality of distribution devices 20 may be coupled to the conduit 18 at various positions along the length of the conduit 18, such that the fluid 22 may exit at more than one exit point. The distribution device 20 may be configured to rotate, spin, or otherwise move in a rotary, circular, or 360-degree pattern about the axis of the conduit 18, such that, as the distribution device 20 rotates, the fluid 22 may be dispersed substantially horizontally across the ground surface 8 on one or more sides of the reservoir 12.

As depicted in FIG. 2, the system 10 may comprise the fluid 22 being dispersed from the distribution device 20 in a circular pattern, as viewed from a bird's eye view above the system 10. The circular pattern of spray of the fluid 22 from the distribution device 20 can be achieved in one or more ways. For example, the distribution device 20 may spray the fluid 22 in a linear spray pattern that sequentially disperses the fluid 22 outwardly and evenly within the entire spray pattern perimeter P as the distribution device 20 rotates steadily about the conduit 18 between 0 and 360 degrees, inclusive, or in a 360-degree range of motion. The distribution device 20 may rotate in either direction D, clockwise or counterclockwise, left or right, or side to side, as indicated in FIG. 2. Alternatively, the distribution device 20 may spray the fluid 22 in a complete 360-degree spray pattern, such that the fluid 22 may be dispersed outwardly within the entire spray pattern perimeter P at the same time without rotation of the distribution device 20. Further in the alternative, the distribution device 20 may spray the fluid 22 in a spray pattern shaped more than the linear spray pattern but less than a 360-degree spray pattern. Then, this spray pattern, such as a 90-degree wedge, can be rotated about the conduit 18 as the distribution device 20 rotates, such that the fluid 22 may be dispersed in this pattern (i.e., wedge) within the entire spray pattern perimeter P. The ability of the distribution device 20 to disperse the fluid 22 over a circular area within the perimeter P, provides that the system 10 may help protect buildings, individuals, or other items and objects 30 within the perimeter P from the spread of wildfire. In other words, the dispersion of the fluid 22 over the area defined within the perimeter P may serve to insulate, protect, defend, shield or otherwise deter the spread of wildfire into the perimeter P.

Embodiments of the system 10 may further comprise the distribution device 20 being controlled or set to focus the spray of fluid 22 on a specific target or area within the perimeter P. As such, the distribution device 20 may be rotated to a specific degree or angle, and thereafter fixed in place to deliver the desired spray pattern in the desired direction of spray. For example, the system 10 may be configured to rotate, and even aim, the distribution device 20 in the direction of one or more of the objects 30, of FIG. 2, within the perimeter P to thereby deliver or disperse the fluid 22 in the direction of, and onto, the object 30 to help protect the object 30 from the spread of wildfire.

Embodiments of the system 10 may further comprise the radial distance R being adjustable either manually or automatically. For example, the distance R may be set and/or adjusted by the pressure levels within the reservoir 12, by the valve 16, or by the distribution device 20. Moreover, the outer perimeter P may also have a size and shape defined by the spray of the fluid 22 from the distribution device 20, such as, for example, a wedge pattern, a rectangular pattern, or the like. In other words, the spray pattern of the distribution device 20 may define the shape and size of the outer perimeter P of the spray area that the fluid 22 may reach.

Embodiments of the system 10 may further comprise the fluid 22. The fluid 22 may be any liquid, or combination of liquids, capable of being contained in the reservoir 12, dispersed through the conduit 18, and dispersed from the distribution device 20 over the desired area of coverage. For example, the fluid 22 may be water or other similar liquid. Further in example, the fluid 22 may be a combination of water and fire-retardant substances, such as for example fire-retardant gels and powders, including powders that may be formulated to turn into a gel when mixed with water and may be ejected from nozzles. The product FIREICE® may be an example of such fire-retardant material. Embodiments of the system 10 may comprise the mixture of water and fire-retardant material/powder being stored in the reservoir 12 and used as the fluid 22. For example, the mixture may be preloaded in the reservoir 12 prior to the reservoir 12 being transported to the desired location of operation. In the alternative, embodiments of the system 10 may comprise water alone being stored in the reservoir 12 and the fire-retardant material/powder being set near the reservoir 12 so that the material/powder may be mixed with the water as the water either passes through the conduit 18 or the distribution device 20, such that the mixture of the water and the material/powder emerges from the distribution device 20 as the fluid 22 and gel mixture described herein. Accordingly, the fire-retardant properties of the fire-retardant substance in the fluid 22 may be dispersed over the entire area of the perimeter P defined by the spray pattern and rotation of the distribution device 20.

Embodiments of the system 10 may further comprise a valve 16 being configured to cooperate with either, or both, of the reservoir 12 and the disbursement device 20 to restrict and permit the flow of the fluid 22 from the reservoir 12, into the conduit 18, and out of the disbursement device 20. For example, the valve 16 may be operationally coupled to the reservoir 12, such that the valve 16 may assist the reservoir 12 in releasing the fluid 22 therefrom. When the valve 16 is in a closed position, no fluid 22 flows into the conduit 18 or out of the disbursement device 20. On the other hand, when the valve is operated to move to the open position, then the fluid 22 flows into the conduit 18 and out of the disbursement device 20. In an alternative configuration, the valve 16 may be operationally coupled to the conduit 18 or disbursement device 20, such that operation of the valve 16 may assist the reservoir 12, the conduit 18, and the disbursement device 20 in releasing the fluid 22 therefrom. For example, the valve 16 may be operationally coupled to the system 10 in the flow path of the fluid 22 between the reservoir 12 and the disbursement device 20, such as in the conduit 18 or disbursement device 20. Yet, regardless of the specific location of the valve 16, when the valve 16 is in the closed position, no fluid 22 flows beyond the position of the valve 16 in the system 10. On the other hand, when the valve 16 is operated to move from the closed position to the open position, then the fluid 22 flows from the reservoir 12, through the conduit 18, and out of the disbursement device 20. The valve 16 may be positioned anywhere between the closed position and the open position to adjust the flow of the fluid 22 out of the disbursement device 20. As such, the radial distance R of the perimeter P can be adjusted. In other words, the spray of the fluid 22 can be adjusted by the valve 16 to thereby adjust the size and shape of the perimeter P. The valve 16 may be operated manually or automatically, which will be described in greater detail herein.

Embodiments of the system 10 may further comprise a fluid flow device 15, such as a pump or compressor, that is operationally coupled to the reservoir 12 to assist with the proper flow of fluid 22 from the reservoir 22. The fluid flow device 15, such as a pump, may be coupled to the reservoir 12 to ensure that the fluid 22 within the reservoir 12 exits (i.e., is pumped from) the reservoir 12, once the valve 16 is open, under the proper pressure and flow velocity to ensure the desired radial distance R of the spray pattern emanating from the disbursement device 20. In like manner, a fluid flow device 15, such as a compressor, may be coupled to the reservoir 12 to ensure that the gas within the reservoir 12 maintains the proper pressure on the fluid 22 to expel or propel the fluid 22 from the reservoir 12, once the valve 16 is open, and ensure the desired radial distance R of the spray pattern emanating from the disbursement device 20. The fluid flow device 15 may be manually or automatically operated, which will be described in greater detail herein.

Embodiments of the system 10 may further comprise the system 10 being configured to operate manually. In other words, manual operation of the valve 16 may cause the fluid 22 to flow from the reservoir 12, through the conduit 18, and out of the disbursement device 20 to spread the fluid 22 over the area within the perimeter P, as described herein.

Embodiments of the system 10 may comprise a control unit 11. The control unit 11 may control and communicate with associated control electronics 9 to govern and dictate the operational aspects of the system 10, including, for example, the operation of the valve 16 and/or the fluid flow device 15. For example, the control unit 11 may be a controller comprising a processor (CPU), circuit board, internal memory, software, control algorithms, inputs, outputs, and other mechanical and electrical components as needed to direct the operations of the system 10. For example, the control unit 11 may be configured to measure the pressure of the fluid 22 and/or gas within the reservoir 12, may be configured to measure the flow rate of the fluid 22 through the conduit 18 or the disbursement device 20, and may be configured to monitor the rotational location and speed of the disbursement device 20, among other features described herein. In other words, the control unit 11 may be configured in such a way that the features of the system 10 described herein are fully automated by the control unit 11. Further, to perform these automated functions, the associated control electronics 9 may be utilized to observe, detect, sense, measure, and communicate operational characteristics of the system 10 and communicate with the control unit 11. The associated control electronics 9 may comprise sensors, gauges, valves, regulators, transducers, solenoids, controllers, wireless communications, and the like for measuring and controlling gas and/or liquid pressure, quantity and flow through the reservoir 12, the conduit 18, the disbursement device 20, among other important operational and control aspects of the system 10. The control unit 11 may be configured to coordinate the operations of each component of the control electronics 9. Each of the components of the control electronics 9 may be configured to also communicate directly with one or more corresponding components, as needed, to perform the desired operations of the system 10. Further, each of the components of the control electronics 9 may be configured to communicate with the control unit 11, as well as directly with one or more corresponding components, as needed, to perform the desired operations of the system 10.

Embodiments of the system 10 may further comprise a power source 7. The power source 7 may be configured to power the system 10, or at least the electrical components of the system 10. The power source 7 may be an electric power cord configured to electrically couple to an external power source, such as a generator or power station or power outlet, to power the system 10. Embodiments of the system 10 may further comprise the power source 7 being a battery, a rechargeable battery, or some combination of both, wherein the batteries may be configured to power the system 10 and/or the electrical operations of the system 10, such as the control unit 11 and the control electronics 9. Embodiments of the system 10 may further comprise the power source 7 being solar panels, solar cells, and rechargeable batteries for storing any electricity generated by solar power, the solar power and/or stored solar power being configured to power the system 10 and/or the electrical operations of the system 10.

Embodiments of the system 10 may further comprise a sensor 14. The sensor 14 may be any sensor capable of measuring or otherwise sensing a characteristic of fire and/or wildfires, such as for example smoke, ash, and heat. The sensor 14 may be, for example, one of a smoke detector, a carbon monoxide detector, an ultraviolet detector, a near infrared (IR) array, IR, IR camera, ultra violet (UV)/IR, IR/IR flame detection, IR3 flame detection, visible sensors, open/close sensors, and video, such as webcams or closed-circuit television. The sensor(s) 14 may be configured to sense a characteristic of a fire or wildfire, and, once sensed, the sensor(s) 14 may communicate with an associated reservoir 12 and/or corresponding control unit 11 or valve 16 to direct the valve 16 to open and permit the flow of the fluid 22 out of the disbursement device 20 and over the area defined within the perimeter P. In this way, the fire retardant may be dispersed onto an area in which fire characteristics have been sensed. Or, in other words, the sensor(s) 14 may be configured to sense the presence of a fire and communicate with the reservoir 12, the valve 16, and/or the control unit 11 to permit the fluid 22 to be sprayed out and onto the fire to extinguish the fire, or at least attempt to prevent the further spread of the fire. The communication between the sensor(s) 14 and the reservoir 12, the valve 16, the control unit 11, or the like may be a wired or wireless communication.

Embodiments of the system 10 may comprise the sensor(s) 14 being positioned on or near the reservoir 12 with which the sensor(s) 14 is to communicate. Positioning the sensor(s) 14 on or near the reservoir 12 provides that the sensor 14 can activate the spray of the fluid 22 from the reservoir 12 located where the fire is located. For example, a residence may have the system 10 positioned near or on its property. Once the sensor(s) 14 sense the presence of the fire, one or more of the sensors 14 may activate the spray of the fluid 22 from the system 10 to reduce the spread of fire or even extinguish the fire entirely. The sensor 14 may be coupled with a home alarm system or a home automation system, such that a residential owner may incorporate the system 10 within the owner's home alarm system or home automation system. The sensor(s) 14 may additionally be configured to add onto an existing home alarm system or home automation system. As such, the system 10 may be configured so that a homeowner may manually activate the system 10 by way of the home alarm system or home automation system, or, in the alternative, that someone who monitors the home alarm system or home automation system may activate the system 10 remotely, or, further in the alternative, the system 10 may be completely automated, as described herein.

Alternatively, embodiments of the system 10 may comprise the sensor(s) 14 being positioned remotely from the reservoir 12 with which the sensor(s) 14 is to communicate. In this way, the sensor(s) 14 can anticipate the spread of the fire and activate the reservoir 12 to disperse the fluid 22, over the area defined by the perimeter P of the associated reservoir 12, in anticipation of the fire to prevent or at least attempt to reduce the spread of the fire into the covered area.

Embodiments of the system 10 may comprise one or more sensor(s) 14 being configured to have a heat sensor 21, an associated trigger/switch mechanism 23, and a communication unit 25 operatively coupled to the trigger mechanism 23 so that the communication unit 25 can place the sensor 14 in wired or wireless communication with the control unit 11 when the trigger mechanism 23 is activated. For example, embodiments of the system 10 may comprise the sensor 14 having a housing body 27 configured to house at least the trigger mechanism 23 and the communication unit 25 therein. The housing body 27 may be a hollow body defined by a perimeter wall. The trigger mechanism 23 and the communication unit 25 may be positioned within the housing body 27 so as to be in operative communication with one another. For example, the trigger mechanism 23 may be configured to move, or slidably translate, within the housing body 27 with respect to the communication unit 25. Alternatively, the communication unit 25 may be configured to move, or slidably translate, within the housing body 27 with respect to the trigger mechanism 23. In certain embodiments, the trigger mechanism 23 may be a magnet that is positioned appropriately and cooperates with the communication unit 25 to form a closed magnetic circuit. Then, once the trigger mechanism 23 moves away from the communication unit 25, or vice versa, the closed magnetic circuit is broken and the communication unit 25 may communicate in response thereto a wired or wireless signal to the associated control unit 11. The trigger mechanism 23 and the communication unit 25 may cooperate with one another and be configured to form a reed sensor or reed switch.

The trigger mechanism 23, or the communication unit 25, may be configured to move, or otherwise slidably translate, in response to activation of the heat sensor 21. The heat sensor 21 may be, for example, a fusible element, a portion of which melts, or a frangible glass bulb containing liquid which breaks, in response to a predetermined temperature. In other words, the sensor 14 may be configured to respond to or otherwise react to a specific predetermined elevated temperature that may be indicative of a wildfire. For example, once the wildfire produces significant enough heat to create a rise in temperature at or above that of the predetermined elevated temperature associated with or assigned to the fusible element of the heat sensor 21, the fusible element will melt causing a seal to drop vertically causing one of the trigger mechanism 23 or the communication unit 25 within the housing 27 to slidably translate within the housing 27, thus breaking the closed magnetic circuit between the trigger mechanism 23 and the communication unit 25 and causing the communication unit 25 to send a wired or wireless signal to the associated control unit 11.

Once the control unit 11 receives the signal from the communications unit 25, the control unit 11 may govern one or more of the valves 16 of the associated reservoirs 12 to open and start the flow of the fluid 22 from the system 10 to reduce the spread of fire or even extinguish the fire entirely. For example, the sensor(s) 14 may be configured at a first distance, such as a first radial distance, away from a to-be-protected structure, such as a building or house. The sensor 14 may therefore be configured to sense and activate in response to the presence of a wildfire, as herein described, send its signal to the control unit 11, and the control unit 11 may determine to activate the valve 16 on a reservoir 12 located a second distance, such as a second radial distance, from the to-be-protected structure, the second radial distance being shorter than the first radial distance and the reservoir 12 being positioned somewhere between the sensor 14 positioned at the first distance and the to-be-protected structure. Also, the control unit 11 may be configured to receive the signal from one or more sensor(s) 14 positioned further away from the to-be-protected structure and activate one or more reservoirs 12 positioned between the sensor(s) 14 and the to-be-protected structure to spray the fluid 22 therefrom to defend against the spread of wildfire by applying a fire-resistant coating onto the surrounding vegetation, to thereby reduce the spread of fire or even extinguish the fire entirely. Indeed, depending on which signal the control unit 11 receives from which particular sensor 14, the control unit 11 may be pre-programmed to activate a predetermined spray pattern or spray sequence or spray distance or spray duration. As such, the control unit 11 may be programmed to activate one or more reservoirs 12 to achieve these varied spray characteristics. Alternatively, the control unit 11 may be programmed to activate one reservoir 12 for each sensor 14 triggered by wildfire. In other words, any number of spray configurations and spray placements may be achieved by the sensor(s) 14 sensing the heat from the wildfire, triggering the communication unit 25, and sending the requisite communication to the control unit 11 for activation of the desired reservoirs 12.

Embodiments of the system 10 may comprise a plurality of systems 10, or an array 100 of systems 10 in communication with one another or with a remote basestation 200. The array 100 of systems 10 may comprise one or more sensors 14 in communication with one or more control units 11 or valves 16 of the associated reservoirs 12 of one or more systems 10. In this way, each of the systems 10 may be capable of sensing a direction of travel of the fire and communicate this direction to a remote location, such as the basestation 200, to another system 10, or to the array 100 of systems 10. The systems 10 may be arranged or positioned in a particular configuration to define an array 100 of systems 10. The array 100 of systems 10 may be manually operated, or may additionally be automatic systems, as described herein, capable of communication with one another or with the base station 200. The communication may be wired or wireless, depending on the circumstances. Accordingly, each of the systems 10 may be configured to wirelessly connect to a communications network, web server, or other internet-enabled devices, and/or the internet through WiFi, cellular modem, Bluetooth, or other similar wireless technology. Moreover, each of the systems 10 may be configured to communicate with one another or the basestation 200 through other known remote communication methods, such as radio, satellite, and the like.

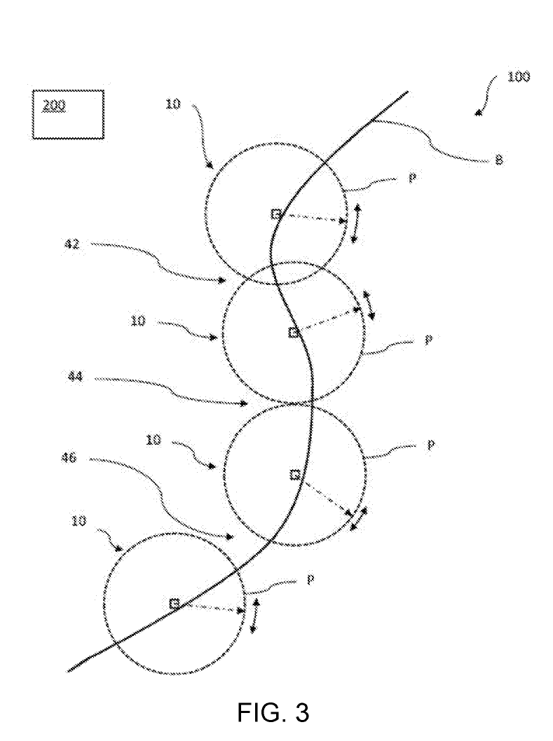

With reference to FIG. 3, any number of the systems 10 may be arranged along a boundary or a border B, the border B being defined based on the intended use of the systems 10. For example, the systems 10 may be arranged in the array 100 of systems 10 along a geographic border, such as a ridge, a waterway, a road, a property border, or electrical lines. The array 100 of systems 10 may be positioned at strategic points along the border B. For example, neighboring systems 10 may be made to create an overlap 44 of their respective spray patterns, wherein the respective areas defined by the perimeters P overlap to some degree. Neighboring systems 10 may also be made to create a contact point 46 between their respective spray patterns, wherein the respective areas defined by the neighboring perimeters P touch edges. Neighboring systems 10 may also be made to create a gap 48 between their respective spray patterns, wherein the respective areas defined by the perimeters P are spaced apart a certain distance from one another. Such gap 48 may permit passage of individuals or vehicles or the like, as needed. Arranging the array 100 of systems 10 along the border B may allow the array 100 of systems 10 to protect the border B from the spread of fire beyond the border B, as the case may be.

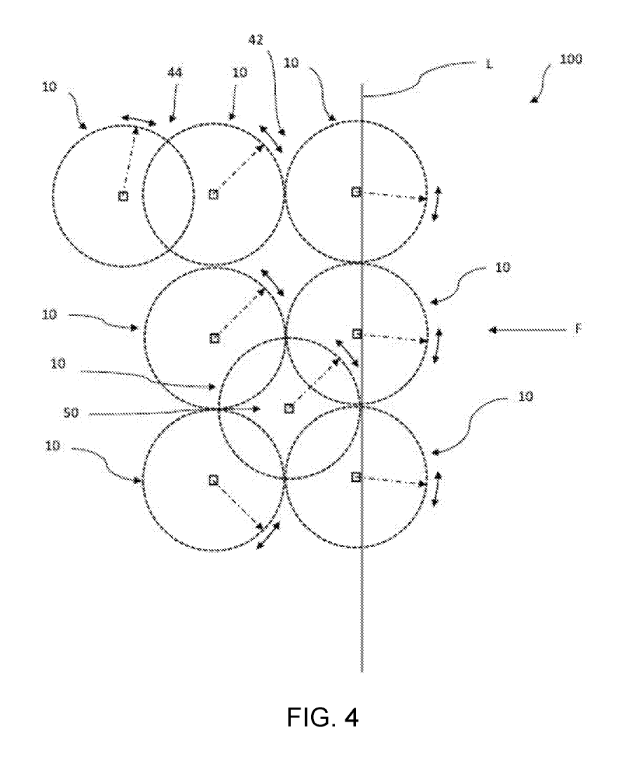

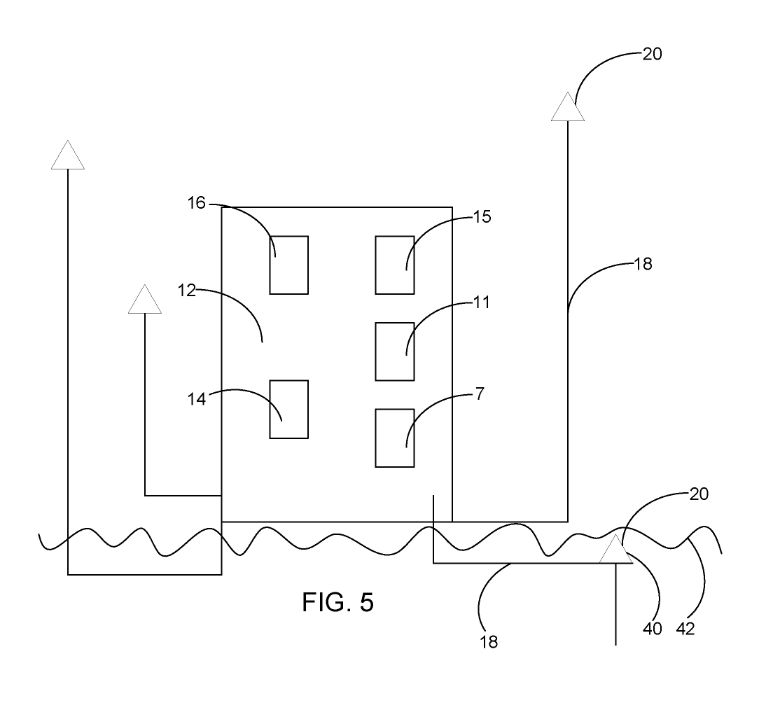

With reference to FIG. 4, any number of the systems 10 may be arranged along a determined path or line L in the array 100 of systems 10. The line L may be a line or path determined by the circumstances of the fire to be addressed. For example, the systems 10 may be deployed in the array 100 of systems 10 along a fire line or other defined fire prevention path. The systems 10 may be deployed on the line L, along the line L for as far a distance as desired, and may be deployed several systems deep behind the line L. As depicted in FIG. 4, the systems 10 may be deployed such that the systems 10 are stacked behind the line L in opposition to a direction of travel of the fire F. The systems 10 may be set such that their perimeters P contact one another at a point (contact 46) or overlap (overlap 44). Alternatively, the systems 10 may be deployed such that the systems 10 create a saturation pattern 50 that does not leave any open space on the surface 8 that is not covered by some perimeter P and thereby some of the fluid 22.

Also, whether arranged along the border B or the line L, the systems 10 and the array 100 of systems 10 may be configured to communicate with any of the systems 10 in the array 100 of systems 10 or with the basestation 200. For example, the sensors 14 of the various systems 10 may communicate with basestation 200 to provide real-time data of the spread of fire or the activation of the various systems 10. The systems 10 and the array 100 of systems 10 may be configured to be operable by the basestation 200 through remote communication, such as radio communication. Alternatively, some of the systems 10 in the array 100 may be manually operable, while others may be automated. For example, some of the systems 10 may be permanently fixed in a ground position and set for automatic or manual operation, whereas other systems 10 may be mobile and likewise set for automatic or manual operation. Using this flexibility in positional location (i.e., mobility of the transportable systems 10) may allow the systems 10 in the array 100 of systems 10 to be changed, altered, or amended to redefine the boundary B or the line L in real time based on the characteristics of the fire sensed by the sensor(s) 14 or the real time operation of any of the systems 10. Thus, the reduction of the spread of the fire or the prevention of the fire can occur in real time.

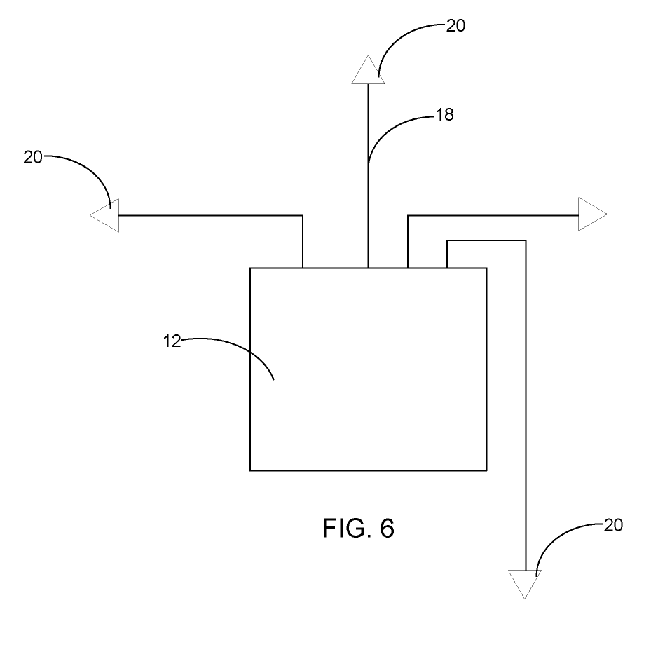

In addition to the components of the system 10 described above, the system 10 can be modified in any suitable manner. Indeed, in some embodiments, instead of comprising a single distribution device 20 in fluidic communication with the reservoir 12, any other suitable number of distribution devices 20 are in fluidic communication with the reservoir. In some cases, 2, 3, 4, 5, 6, 7, 8, 9, 10, or more distribution devices 20 are in fluidic communication with a single reservoir 12. By way of non-limiting illustration, FIGS. 5 and 6 show some representative embodiments, in which a plurality of distribution devices 20 are in fluidic communication with the reservoir 12.

Where multiple distribution devices 20 are in fluidic communication with a corresponding reservoir 12, the distribution devices 20 can be disposed in any suitable location with respect to their corresponding reservoir 12. In some embodiments, one or more distribution devices are configured to be coupled to one or more conduits 18 that extend above, below, to the side of, and/or in any other suitable location with respect to the reservoir 12. By way of non-limiting illustration, FIGS. 5 and 6 show some embodiments in which at least one distribution device 20 is disposed above its corresponding reservoir 12. Additionally, FIG. 5 shows that, in some embodiments, one or more distribution devices 20 (e.g., distribution device 40) is disposed (at least initially) below a top surface of the corresponding reservoir 12. In some such embodiments, such a distribution device 40 can function much in any suitable manner, including, without limitation, by: being fixed in position (e.g., so as to not raise or lower upon activation), being able to pop-up to a set height upon activation, being able to telescope up to a set height upon activation, and/or otherwise functioning in any suitable manner. Indeed, FIG. 5 shows that in some embodiments one or more distribution devices 40 are disposed within the ground 42 so as to have a fixed height and/or so as to raise to a set height upon activation.

In addition to the components of the system 10 described above, methods of using the system 10 are herein described. The method may comprise providing one or more fire retardant delivery systems 10 of the like described herein. The method may comprise arranging the system in a desired location. The method may comprise sensing a characteristic of a fire and enabling the system to activate based on the sensed characteristic. The method may comprise ejecting a fluid containing fire retardant in a pattern about the system. The method may comprise transporting or otherwise moving the system to a fire location and deploying one or more systems in an array of systems to collectively battle a fire or at least reduce the spread of fire. The method may comprise the systems communicating with one another or with a basestation. The method may comprise directing the operation of one or more systems in the array of systems from a remote location from the systems or the array of systems, such as by the basestation or other wired or wireless communication. The method may comprise applying the fluid to the area to be protected prior to the fire. The method may comprise applying the fluid to the area to be protected after the fire has been detected. The method may comprise applying the fluid to the area to be protected after the fire has been detected in the area to be protected. The method may comprise incorporating the operations of the system into a home alarm system or home automation system. The method may comprise dynamically changing or altering the array of systems based on the sensors sensing the characteristics of the fire to thereby dynamically fight or reduce the spread of the fire in real time.

The materials of construction of the system 10, may be formed of any of many different types of materials or combinations thereof that can readily be formed into shaped objects provided that the components selected are consistent with the intended operation of fire retardant delivery systems of the type disclosed herein. For example, and not limited thereto, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described system 10 may be purchased pre-manufactured or manufactured separately and then assembled together. However, any or all of the components may be manufactured simultaneously and integrally joined with one another. Manufacture of these components separately or simultaneously may involve extrusion, protrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, 3-D printing, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components, for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A fire retardant delivery system comprising:
a reservoir containing a fluid under pressure;
a distribution device in fluidic communication with the reservoir; and
a sensor for sensing characteristics of a fire, wherein the fluid is delivered to ambient surroundings upon direction from the sensor.

2. The system of claim 1, further comprising a conduit between the reservoir of fluid and the distribution device, wherein the conduit elevates the distribution device above surrounding buildings and vegetation.

3. A fire retardant delivery system comprising:
a plurality of reservoirs containing a fluid under pressure, wherein the fluid contains a fire retardant;
a distribution device in fluidic communication with each of the reservoirs; and
a sensor for sensing characteristics of a fire, wherein each of the reservoirs is positioned in sequence along a predetermined path, and wherein the fluid is delivered to ambient surroundings from each of the distribution devices upon direction from the sensor.

4. The system of claim 1, wherein the path is a fire line.
